(19) United States
(12) Patent Application Publication
(10) Pub. No.: US 2024/0345825 A1
(43) Pub. Date: Oct. 17, 2024

(54) SERVER, SOFTWARE UPDATE METHOD, NON-TRANSITORY STORAGE MEDIUM, AND SOFTWARE UPDATE SYSTEM

(71) Applicant: TOYOTA JIDOSHA KABUSHIKI KAISHA, Toyota-shi (JP)

(72) Inventor: Naoki KOUGE, Kasugai-shi (JP)

(73) Assignee: TOYOTA JIDOSHA KABUSHIKI KAISHA, Toyota-shi (JP)

(21) Appl. No.: 18/588,966

(22) Filed: Feb. 27, 2024

(30) Foreign Application Priority Data
Apr. 17, 2023 (JP) 2023-067153

(51) Int. Cl. G06F 8/65

(52) U.S. Cl. CPC G06F 8/65

(57) ABSTRACT

A server includes one or more processors. The one or more processors are configured to: transmit updated software to vehicle that is registered; receive information on cancelation of application of the updated software; and when the information on cancelation of application of the updated software is received, transmit, to the vehicle to which the updated software has already been transmitted, a cancelation signal ordering cancelation of an update to the updated software.

### CROSS-REFERENCE TO RELATED APPLICATION

This application claims priority to Japanese Patent Application No. 2023-067153 filed on Apr. 17, 2023, incorporated herein by reference in its entirety.

### BACKGROUND

### 1. Technical Field

The present invention relates to a server, a software update method, a non-transitory storage medium, and a software update system.

### 2. Description of Related Art

The software update system disclosed in Japanese Unexamined Patent Application Publication No. 2022-109039 (JP 2022-109039 A) includes a server and an over-the-air (OTA) master installed in a vehicle. The OTA master manages updates of software of electronic control devices installed in the vehicle. The OTA master can wirelessly communicate with the server.

The server manages software of the vehicle. When there is new updated software applicable to the vehicle, the server transmits the new updated software to the OTA master. Upon receiving the new updated software from the server, the OTA master performs a process for updating the software of a corresponding electronic control device to the updated software.

### SUMMARY

In such a technology as JP 2022-109039 A, the server sometimes receives information on a defect in updated software after the server has once transmitted that updated software to the vehicle. The technology of JP 2022-109039 A does not give any consideration to how to deal with cases where such a situation has arisen.

A server in one aspect of this disclosure includes one or more processors. The one or more processors are configured to: transmit updated software to vehicle that is registered; receive information on cancelation of application of the updated software; and in response to receiving the information on cancelation of application of the updated software, transmit, to the vehicle to which the updated software has already been transmitted, a cancelation signal ordering cancelation of an update to the updated software.

In the server according to the first aspect of this disclosure, the one or more processors may be configured to receive, from the vehicle, status information showing at which stage from start to completion the update to the updated software is, and to transmit the cancelation signal to the vehicle in which the update to the updated software has not been completed.

A method of updating software by a computer in a second aspect of this disclosure includes the computer executing: transmitting updated software to vehicle that is registered; receiving information on cancelation of application of the updated software; and in response to receiving the information on cancelation of application of the updated software, transmitting, to the vehicle to which the updated software has already been transmitted, a cancelation signal ordering cancelation of an update to the updated software

A non-transitory storage medium in a third aspect of this disclosure stores a command that is executable by one or a plurality of processors and that makes the one or the plurality of processors execute the following functions. These functions include: transmitting updated software to vehicle that is registered; receiving information on cancelation of application of the updated software; and when the information on cancelation of application of the updated software is received, transmitting, to the vehicle to which the updated software has already been transmitted, a cancelation signal ordering cancelation of an update to the updated software.

A software update system in a fourth aspect of this disclosure includes a server and an information processing device that is installed in vehicle and configured to communicate with the server. The server is configured to transmit updated software to the information processing device, and to receive information on cancelation of application of the updated software. The information processing device is configured to receive the updated software from the server, and to perform an update to the updated software for an electronic control device installed in the vehicle. The server is configured to, in response to receiving the information on cancelation of application of the updated software, transmit, to the information processing device to which the updated software has already been transmitted, a cancelation signal ordering cancelation of the update to the updated software. The information processing device is configured to, in response to receiving the cancelation signal from the server before completion of the update to the updated software, cancel the update to the updated software.

In the software update system according to the fourth aspect of this disclosure, in performing the update to the updated software, the information processing device may be configured to: perform downloading to receive the updated software from the server; perform installation to store the updated software obtained by the downloading in the electronic control device; perform activation to enable the updated software of which the installation has been performed; and transmit, to the server, status information showing at which stage among the downloading, the installation, and the activation the update to the updated software is. The server may be configured to transmit the cancelation signal to the information processing device in which the activation has not been completed.

In the software update system according to the fourth aspect of this disclosure, the server may be configured to transmit the cancelation signal to the information processing device in which the installation is yet to be executed. The information processing device may be configured to, in response to receiving the cancelation signal is received, delete the updated software before storing the updated software in the electronic control device.

Each of the above-described technological ideas can reduce the likelihood that an update to defective updated software is performed.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a schematic configuration diagram of a vehicle management system;

FIG. 2 is a sequence chart showing a flow of an update to updated software;

FIG. 3 is a sequence chart showing a first cancelation pattern;

FIG. 4 is a sequence chart showing a second cancelation pattern; and

FIG. 5 is a sequence chart showing a modified example in a case of canceling an update.

### DETAILED DESCRIPTION OF EMBODIMENTS

An embodiment of a server, a software update method, a non-transitory storage medium, and a software update system will be described below with reference to the drawings.

### Server Unit

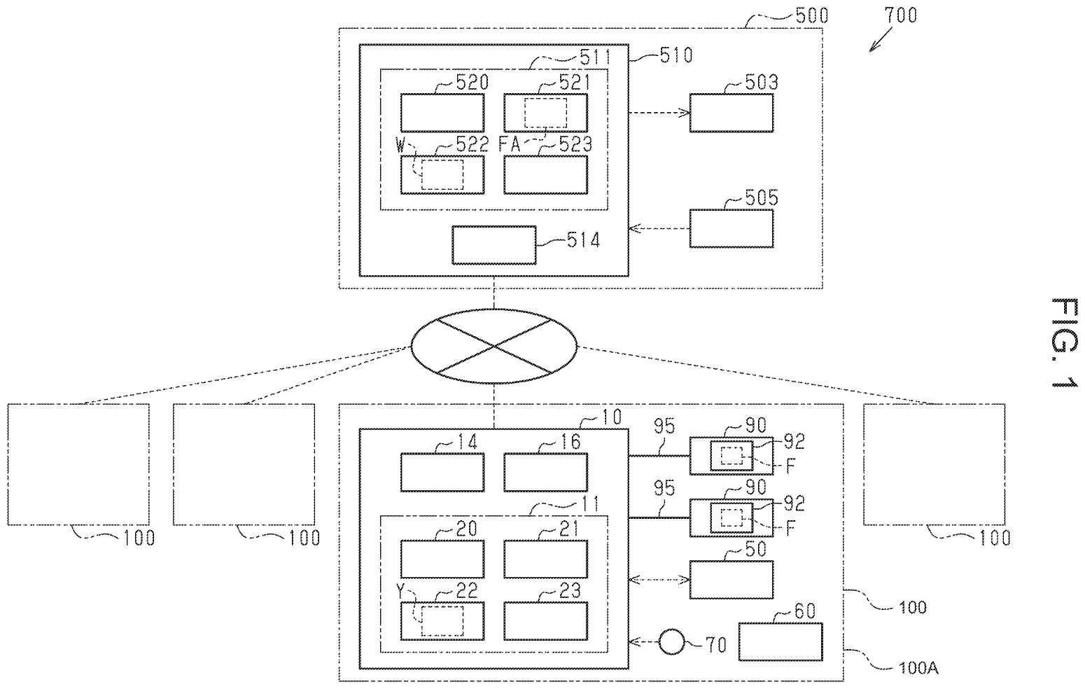

As shown in FIG. 1, a vehicle management system 700 includes a server unit 500 and a plurality of vehicles 100. The plurality of vehicles 100 is vehicles that are registered beforehand in the server unit 500 as management targets.

The server unit 500 includes a management server 510, a display 503, and an input device 505.

The management server 510 is a computer. The management server 510 includes a processing circuit 511. The processing circuit 511 includes a CPU 520, a first memory 521, a second memory 522, and a third memory 523. The first memory 521 is a non-volatile storage medium. The first memory 521 is electrically rewritable. The first memory 521 functions as a storage to store data. The second memory 522 is a non-volatile storage medium. The second memory 522 is electrically rewritable. The second memory 522 stores software for the management server 510. The software for the management server 510 is a collection of various programs W in which processes to be executed by the CPU 520 of the management server 510 are written. The third memory 523 is a volatile storage medium. The management server 510 includes a communication module 514. The communication module 514 is a communication circuit for wirelessly communicating with an outside through an external communication line network.

The display 503 includes a drive circuit and a display screen. The display 503 is communicably connected to the management server 510. The display 503 displays, on the display screen, an image according to an instruction signal transmitted by the CPU 520 of the management server 510.

The input device 505 is communicably connected to the management server 510. The input device 505 is a device for inputting information into the management server 510 from the outside. The input device 505 is, for example, a keyboard and a mouse.

The first memory 521 of the management server 510 stores a vehicle list. The vehicle list is a list in which, for the plurality of vehicles 100 already registered, the following two pieces of information are associated with each vehicle 100: One information is a vehicle identification value assigned to the vehicle 100. The other information is basic information, such as the vehicle type and the model of the vehicle 100.

The first memory 521 of the management server 510 stores a plurality of pieces of updated software FA for vehicles. As the updated software FA for vehicles, the latest software applicable to the respective vehicles 100 according to the classification of the vehicle type and the model, for example, is prepared. Each updated software FA is assigned an individual software identification value. The software identification value reflects the type and version information of the updated software FA. The software identification value is, for example, written as header information in each updated software FA.

### Vehicle

Each vehicle 100 has the same basic configuration. This basic configuration will be described below. The vehicle 100 includes an OTA master 10. The OTA master 10 is an information processing device installed in the vehicle 100. The OTA master 10 is a computer. The OTA master 10 includes a processing circuit 11. The processing circuit 11 includes a CPU 20, a first memory 21, a second memory 22, and a third memory 23. The first memory 21 is a non-volatile storage medium. The first memory 21 is 20 electrically rewritable. The first memory 21 functions as a storage to store data. The second memory 22 is a non-volatile storage medium. The second memory 22 is electrically rewritable. The second memory 22 stores software for the OTA master 10. The software for the OTA master 10 is a collection of various programs Y in which processes to be executed by the CPU 20 of the OTA master 10 are written. The third memory 23 is a volatile storage medium. The OTA master 10 includes a communication module 14. The communication module 14 is a communication circuit for wirelessly communicating with an outside of the vehicle through an external communication line network. The OTA master 10 includes a real-time clock 16. The real-time clock 16 is a circuit that generates information on a date and time. A cluster of OTA masters 10 in the plurality of vehicles 100 registered in the management server 510 and the management server 510 constitute a software update system.

The vehicle 100 includes a plurality of electronic control devices 90. In FIG. 1, two of the plurality of electronic control devices 90 are shown as representatives. Each electronic control device 90 can communicate with the OTA master 10 through a bus 95. Each electronic control device 90 controls a specific one among a plurality of on-board devices as a target. One example of the on-board devices is an engine serving as a drive source of the vehicle 100. Another example of the on-board devices is a hydraulic brake device. Other examples of the on-board devices include an air conditioning device, a meter display device, a car navigation device, an audio device, and a direction indicator. The types and models of the on-board devices installed in the vehicle 100 can be different among the vehicles 100.

The electronic control device 90 is a computer. The electronic control device 90 includes a processing circuit similar to that of the OTA master 10. That is, the electronic control device 90 includes a CPU, a non-volatile first memory, a non-volatile second memory 92, and a volatile third memory. The second memory 92 stores software F for the electronic control device 90. The software F for the electronic control device 90 is a collection of various programs in which processes to be executed by the CPU of the electronic control device 90 are written. The non-volatile memories adopted in the electronic control device 90 have a double-bank (dual-bank) structure. In a memory with a double-bank structure, there are two storage areas. While data in one storage area of this memory is being read, the CPU can write into the other storage area thereof. For example, the non-volatile memories of the OTA master 10 also have a double-bank structure.

In connection with the above-described electronic control device 90, the first memory 21 of the OTA master 10 stores a software list. The software list is a list in which, for the plurality of electronic control devices 90 in the vehicle 100 equipped with the OTA master 10, the following two pieces of information are associated with each electronic control device 90: One information is an identification value assigned to the electronic control device 90. The other information is a software identification value of the software F that is applied to the electronic control device 90 at a current point.

The vehicle 100 includes a display 50. The display 50 is located inside a vehicle cabin of the vehicle 100. The display 50 includes a drive circuit and a display screen. The display 50 is communicably connected to the OTA master 10. The display 50 displays, on the display screen, an image according to an instruction signal transmitted by the CPU 20 of the OTA master 10. The display 50 is of a touch-screen type. That is, when an occupant performs an input operation on the display screen of the display 50, the display 50 transmits a signal according to that input operation to the OTA master 10. The display 50 is one of the plurality of on-board devices. Therefore, the display 50 is connected to the OTA master 10 through a dedicated electronic control device 90 (not shown).

The vehicle 100 includes a battery 60. The battery 60 supplies electric power to on-board components, for example, the OTA master 10, the electronic control devices 90, and the display 50.

The vehicle 100 includes a start switch 70. The start switch 70 is sometimes called an ignition switch, a system start switch, etc. The start switch 70 is a switch for the occupant to order that the vehicle 100 be started. As the start switch 70 is turned on or off by the occupant, the system of the vehicle 100 turns on or off. In a state where the system of the vehicle 100 is on, the OTA master 10, the electronic control devices 90, and the on-board devices are in an active state. On the other hand, in a state where the system of the vehicle 100 is off, the electronic control devices 90 and the on-board devices are in an inactive state. Also in the state where the system of the vehicle 100 is off, the OTA master 10 is in the active state by receiving a supply of electric power from the battery 60. Also in the state where the system of the vehicle 100 is off, the electronic control devices 90 and the display 50 temporarily assume the active state by receiving a supply of electric power from the battery 60 when it is necessary to perform a process, for example, when the software Fis to be updated. The OTA master 10 receives a signal indicating a state of the vehicle 100 according to the on or off operation of the start switch 70. The OTA master 10 can thereby grasp whether the system of the vehicle 100 is on or off.

### Overview of Server-Side Process

The management server 510 can execute a server-side process as the CPU 520 executes the programs W stored in the second memory 522. The server-side process is a process that the management server 510 performs when updating the software F of the electronic control device 90 to the updated software FA in a specific vehicle 100. The server-side process is essentially a process of responding to a vehicle-side process to be described later. In the server-side process, using wireless communication, the management server 510 transmits and receives information to and from the OTA master 10 of a vehicle-to-be-updated 100A that is the vehicle 100 being the target of the update. For example, the management server 510 transmits the updated software FA to the OTA master 10 of the vehicle-to-be-updated 100A. The management server 510 receives status information from the OTA master 10 of the vehicle-to-be-updated 100A. The status information is information showing at which stage from start to completion the update to the updated software FA is. As part of the server-side process, the management server 510 receives information on cancelation of application of the updated software FA. The information on cancelation of application of the updated software FA is input into the management server 510 as an operator operates the input device 505. This will be described in detail later. In the case where the information on cancelation of application of the updated software FA is received after the management server 510 has transmitted the updated software FA to the vehicle-to-be-updated 100A, the management server 510 performs the following: The management server 510 transmits a cancelation signal to the OTA master 10 of the vehicle-to-be-updated 100A to which the updated software FA has already been transmitted. The cancelation signal is a signal ordering that execution of the update to the updated software FA be canceled. Regarding transmitting the cancelation signal, specifically, the management server 510 transmits the cancelation signal to the vehicle-to-be-updated 100A to which the updated software FA has already been transmitted and in which the update to the updated software FA has not been completed.

As has been described above, the various programs W stored in the second memory 522 include an update program for software relating to an update of the software F of the vehicle 100. The CPU 520 of the management server 510 that executes this program is a controlling actor in the software update method.

### Reception of Cancelation of Application

The above-described reception of the information on cancelation of application of the updated software FA will be described. Here, as described above, the first memory 521 of the management server 510 stores the plurality of pieces of updated software FA for vehicles to be distributed to the vehicles-to-be-updated 100A. In addition to storing this plurality of pieces of updated software FA, the first memory 521 of the management server 510 stores a management list for managing this plurality of pieces of updated software FA. In particular, the management list is a list in which, for the plurality of pieces of updated software FA stored in the first memory 521, the following plurality of pieces of information is associated with each updated software FA. One of the plurality of pieces of information is a software identification value of the updated software FA. Another of the plurality of pieces of information is a specific numerical value or name that characterizes the version of the updated software FA. Hereinafter, this information will be referred to as version feature information. Another of the plurality of pieces of information is an identification value of a target control device that is the electronic control device 90 to which the updated software FA is applied. Another of the plurality of pieces of information is the name of the on-board device that the target control device controls as the target. Hereinafter, this information will be referred to as a target device name.

When a defect is found in the updated software FA stored in the first memory 521, the operator inputs application cancelation information into the management server 510 using the input device 505. The application cancelation information includes information about the affected updated software FA and information to the effect that application of that updated software FA is to be canceled. The information about the affected updated software FA is, for example, the target device name and the version feature information.

When this application cancelation information is input, the management server 510 refers to the management list stored in the first memory 521. Based on the management list, the management server 510 specifies the software identification value of the updated software FA of which application is to be canceled. Based on this software identification value, the management server 510 orders the OTA master 10 of the vehicle-to-be-updated 100A to cancel application of the affected updated software FA. When the management server 510 receives the information on cancelation of application of the updated software FA, the management server 510 promptly deletes that updated software FA from the first memory 521.

### Overview of Vehicle-Side Process

The OTA master 10 can execute the vehicle-side process as the CPU 20 executes the programs Y stored in the second memory 22. The vehicle-side process is a process in which, for the electronic control device 90 installed in the host vehicle, the OTA master 10 updates the software F to the updated software FA. As described in connection with the server-side process, the management server 510 performs wireless communication with the management server 510 for the update to the updated software FA. Such a technology of updating software using wireless communication is sometimes called an over-the-air (OTA) technology etc.

In the vehicle-side process, the OTA master 10 performs the following three stages of processing to perform the update to the updated software FA. The three stages of processing are downloading, installation, and activation. The downloading is for the OTA master 10 to receive the updated software FA from the management server 510 and store the received updated software FA in its first memory 21. The installation is for the OTA master 10 to store the updated software FA obtained by the downloading in the electronic control device 90 to be updated (to write the updated software FA into the second memory 92 included in the electronic control device 90 to be updated). The activation is for the OTA master 10 to enable, for the electronic control device 90 to be updated, the updated software FA of which the installation has been performed. Regarding the installation and the activation, the OTA master 10 transmits instruction signals for performing these processes to the electronic control device 90. In response to the instruction signals, the electronic control device 90 performs the respective processes instructed. Since the OTA master 10 gives instructions for the installation and the activation, the controlling actor that performs the installation and the activation is the OTA master 10. Thus, the OTA master 10 performs the installation and the activation.

The activation will be described in detail. In particular, the activation is changing the contents of settings of the electronic control device 90 as follows: The activation is changing the software that the electronic control device 90 reads to perform various processes from the currently existing software F to the updated software FA. One example for performing this change is changing the setting of a reading flag in the electronic control device 90. The reading flag is a flag that specifies a storage area to which software is to be read. As the setting of the reading flag is changed, in the electronic control device 90, the storage area to which software is to be read switches from the storage area in which the currently existing software F is stored to a storage area in which the updated software FA is stored.

Regarding the above-described three stages of processing, starting the downloading corresponds to starting the update to the updated software FA. Completing the activation corresponds to completing the update to the updated software FA. The OTA master 10 transmits, to the management server 510, information showing at which stage the update to the updated software FA is in the sequential process from the start to completion of the update. This information is the status information described in the overview of the server-side process. Specifically, the status information is information showing at which stage among the downloading, the installation, and the activation the update to the updated software FA is. With this status information taken into account, the management server 510 transmits the cancelation signal before completion of the activation. When the OTA master 10 receives the cancelation signal from the management server 510, the OTA master 10 cancels the update to the updated software FA. When the OTA master 10 receives the cancelation signal before execution of the installation, the OTA master 10 deletes the updated software FA before storing this updated software FA in the electronic control device 90. When the OTA master 10 receives the cancelation signal after execution of the installation and before execution of the activation, the OTA master 10 deletes the updated software FA from the electronic control device 90 before switching the storage area to which software is to be read in the electronic control device 90. As with the above-described controlling actor in the installation and the activation, the controlling actor in deleting the updated software FA from the electronic control device 90 is the OTA master 10.

### Sequential Flow of Update to Updated Software

In this embodiment, a series of processes that the OTA master 10 executes to perform the update to the updated software FA is the vehicle-side process. That is, the processes of step S10 to step S28A and further the processes of step S22B and step S28B, to be described later, that are performed by the OTA master 10 compose one vehicle-side process. In this embodiment, a series of processes that the management server 510 performs in response to the process of one step in the vehicle-side process is the server-side process. There is a plurality of stages of the server-side process corresponding to stages of the update to the updated software FA. For example, as will be described next, in response to the process of step S10 performed by the OTA master 10 of the vehicle-to-be-updated 100A, the management server 510 performs the processes of step S610 and step S612. These step S610 and step S612 compose one stage of the server-side process. The same applies to other processes performed by the management server 510. The management server 510 starts the respective stages of the server-side process by being triggered by reception of various pieces of information that are sent from the OTA master 10 of the vehicle-to-be-updated 100A. The management server 510 ends each stage of the server-side process with transmission of information according to a request from the OTA master 10 of the vehicle-to-be-updated 100A to the OTA master 10. In the following, case-by-case description of the start and end of each stage of the server-side process will be omitted. The process of receiving the information on cancelation of application of the updated software FA constitutes a server-side process for reception by itself. This server-side process for reception is being always performed.

The flow of the update to the updated software FA will be described using, as an example, a case where one electronic control device 90 in one vehicle-to-be-updated 100A is the target. The number of pieces of the software F that one electronic control device 90 has is one. In the following, therefore, interaction between the vehicle-to-be-updated 100A and the management server 510 for one updated software FA as the target will be described.

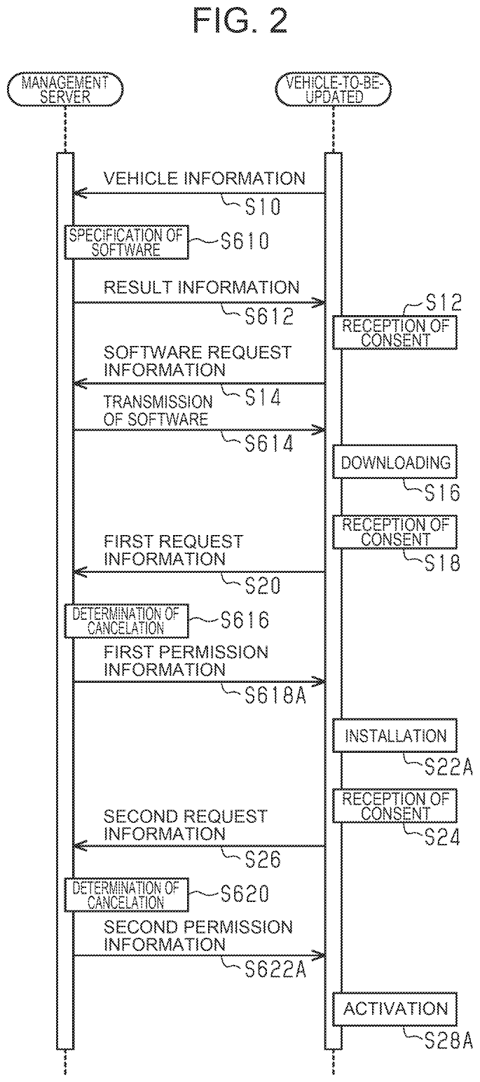

When the system of the vehicle-to-be-updated 100A switches from off to on, the OTA master 10 of the vehicle-to-be-updated 100A starts the vehicle-side process. As shown in FIG. 2, in the vehicle-side process, the OTA master 10 first executes the process of step S10. In step S10, the OTA master 10 transmits vehicle information on the host vehicle to the management server 510. The vehicle information includes the vehicle identification value of the host vehicle and the software list of the host vehicle. As described above, the software list is information in which each electronic control device 90 and the currently existing software F in the electronic control device 90 are associated with each other.

Upon receiving the vehicle information from the vehicle-to-be-updated 100A, the management server 510 performs the process of step S610. In step S610, based on the vehicle information on the vehicle-to-be-updated 100A, the management server 510 specifies the new updated software FA applicable to the vehicle-to-be-updated 100A from among the plurality of pieces of updated software FA stored in the first memory 521. Hereinafter, this updated software FA will be referred to as specific software FAS. Regarding the process of step S610, when there is no new updated software FA applicable to the vehicle-to-be-updated 100A, the management server 510 grasps the situation where there is no new updated software FA.

After the process of step S610, the management server 510 performs the process of step S612. In step S612, the management server 510 transmits result information showing the result of the process of step S610 to the vehicle-to-be-updated 100A. When there is new updated software FA applicable to the vehicle-to-be-updated 100A (specific software FAS), the result information includes information to the effect that there is new updated software FA and the software identification value of the specific software FAS. When there is no new updated software FA applicable to the vehicle-to-be-updated 100A, the result information includes information to the effect that there is no new updated software FA.

Upon receiving the result information from the management server 510, the OTA master 10 of the vehicle-to-be-updated 100A performs the process of step S12. In step S12, the OTA master 10 first determines whether to continue the vehicle-side process based on the received result information. When there is no new updated software FA, the OTA master 10 ends the vehicle-side process at that point. On the other hand, when there is new updated software FA, the OTA master 10 continues the vehicle-side process. When continuing the vehicle-side process, the OTA master 10 stores the result information received from the management server 510 in its first memory 21. Thereafter, the OTA master 10 makes the processing transition to the process of obtaining consent to the update from the occupant. Specifically, the OTA master 10 displays a consent image on the display 50. The consent image includes a first message asking the occupant whether the downloading of the specific software FAS may be executed, a consent button, and a rejection button. The consent button is a button for the occupant to consent to execution of the update. The rejection button is a button for the occupant to reject execution of the update. When the OTA master 10 has displayed the consent image on the display 50, the OTA master 10 determines the flow of the subsequent process according to whether a consent condition is met. The consent condition is that, after the OTA master 10 has displayed the consent image on the display 50, the occupant operates the consent button in the consent image before a predetermined standby time that is specified beforehand elapses. The predetermined standby time is, for example, 30 seconds. When the consent condition is met, the OTA master 10 ends displaying of the consent image and then moves the processing to step S14. On the other hand, when the consent condition is not met, the OTA master 10 ends displaying of the consent image and ends the vehicle-side process. A case where the consent condition is not met is either a case where the occupant operates the rejection button before the predetermined standby time elapses, or a case where the predetermined standby time elapses without the consent button or the rejection button being operated.

When the OTA master 10 has moved the processing to step S14, the OTA master 10 transmits software request information to the management server 510. The software request information includes the vehicle identification value of the host vehicle, the software identification value of the specific software FAS included in the above-described result information, and information to the effect that transmission of the specific software FAS is requested.

Upon receiving the software request information from the vehicle-to-be-updated 100A, the management server 510 performs the process of step S614. In step S614, the management server 510 transmits the specific software FAS of which transmission has been requested to the vehicle-to-be-updated 100A.

In response to the above-described process of step S614, the OTA master 10 of the vehicle-to-be-updated 100A performs the process of step S16. In step S16, the OTA master 10 performs the downloading of the specific software FAS. Specifically, the OTA master 10 receives the specific software FAS transmitted from the management server 510 and stores the received specific software FAS in its first memory 21. At this point, the vehicle-to-be-updated 100A becomes a vehicle 100 to which the specific software FAS has already been transmitted. After the process of step S16, the OTA master 10 moves the processing to step S18.

In step S18, the OTA master 10 displays a consent image similar to that of step S12 on the display 50. This consent image is different from the consent image of step S12 in that, instead of the above-described first message, a second message asking the occupant whether the installation may be executed is included. When the OTA master 10 has displayed the consent image on the display 50, the OTA master 10 determines the flow of the subsequent process according to whether the above-described consent condition is met. When the consent condition is met, the OTA master 10 moves the processing to step S20. On the other hand, when the consent condition is not met, the OTA master 10 temporarily ends displaying of the consent image and stands by until the system of the vehicle-to-be-updated 100A switches from off to on next time. In this case, when the system of the vehicle-to-be-updated 100A switches from off to on next time, the OTA master 10 displays the consent image on the display 50 again. Thus, in this case, the OTA master 10 carries over the processing of step S18 to a next vehicle trip. The vehicle trip is a period from when the system of the vehicle-to-be-updated 100A turns on until when it turns off. When the OTA master 10 has carried over the processing of step S18 to the next vehicle trip as the consent condition has not been met, the OTA master 10 determines the flow of the subsequent process again according to whether the consent condition is met. When the consent condition is eventually met according to the occupant's operation, the OTA master 10 moves the processing to step S20. Here, regarding the case where the processing of step S18 is carried over to the next vehicle trip as described above, the OTA master 10 is set as follows: The OTA master 10 is set so as not to redundantly execute the vehicle-side process. Therefore, when the OTA master 10 carries over the processing of step S18 to the next vehicle trip, the OTA master 10 does not start a new vehicle-side process when the next vehicle trip starts. The same applies to step S24 to be described later.

In step S20, the OTA master 10 transmits first request information asking for permission for the installation to the management server 510. This first request information includes the vehicle identification value of the host vehicle, the software identification value of the specific software FAS, and information that inquires whether the installation of the specific software FAS may be executed. This first request information is status information showing that the update to the specific software FAS is at a stage before execution of the installation.

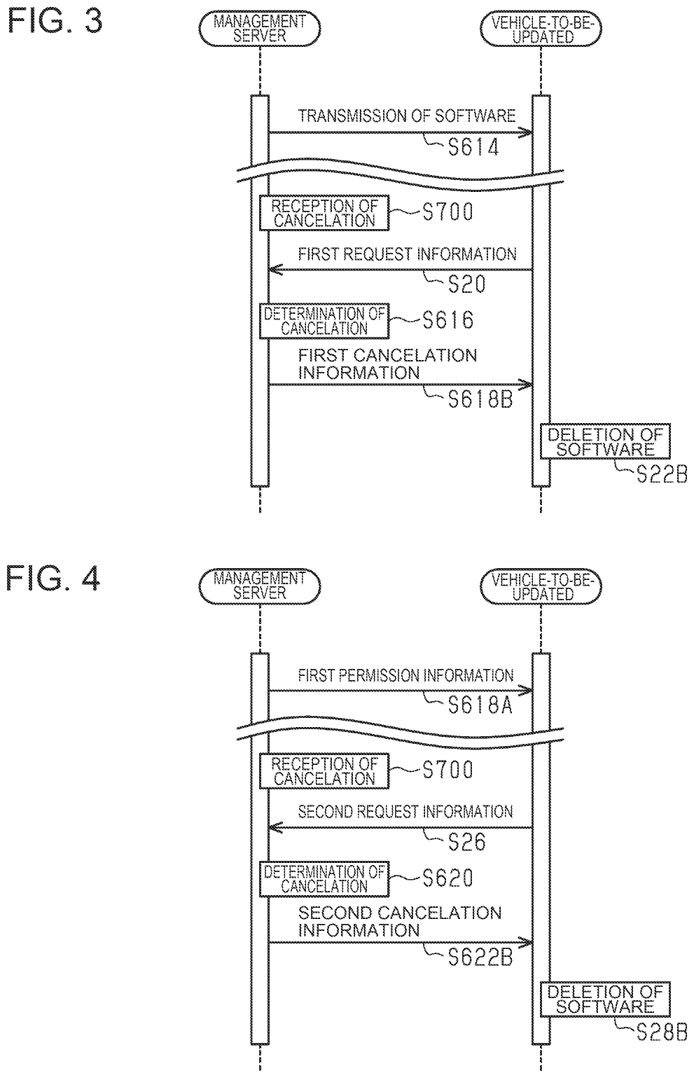

Upon receiving the first request information from the vehicle-to-be-updated 100A, the management server 510 performs the process of step S616. In step S616, the management server 510 determines whether it is necessary to cancel the update to the specific software FAS. When the management server 510 has not received the information on cancelation of application of the specific software FAS from when the process of step S614 has been ended until when the process of step S616 has been started, the management server 510 determines that it is not necessary to cancel the update. In this case, the management server 510 performs the process of step S618A. On the other hand, as shown in FIG. 3, when the management server 510 has received the information on cancelation of application of the updated software FA from when the process of step S614 has been ended until when the process of step S616 has been started (step S700), the management server 510 performs a process of a first cancelation pattern to be described later.

As shown in FIG. 2, when the management server 510 has moved the processing to step S618A, the management server 510 transmits first permission information to the vehicle-to-be-updated 100A. The first permission information includes the software identification value of the specific software FAS and a first permission signal indicating permission for execution of the installation.

Upon receiving the first permission information from the management server 510, the OTA master 10 of the vehicle-to-be-updated 100A performs the process of step S22A. In step S22A, the OTA master 10 performs the installation of the specific software FAS of which the downloading has been performed in step S16. Specifically, the OTA master 10 transmits the specific software FAS and an instruction signal for storing the specific software FAS to the electronic control device 90 to be updated. In response to this instruction signal, the electronic control device 90 to be updated stores the specific software FAS in its second memory 92. Upon completing storing of the specific software FAS, the electronic control device 90 to be updated transmits a first completion signal indicating to that effect to the OTA master 10. The installation is completed when the OTA master 10 receives this first completion signal. Upon receiving the first completion signal, the OTA master 10 moves the processing to step S24.

In step S24, the OTA master 10 stands by until the system of the vehicle-to-be-updated 100A switches from on to off. When the system of the vehicle-to-be-updated 100A switches from on to off, the OTA master 10 displays a consent image on the display 50 as in step S18. This consent image is different from the consent image of step S18 in that, instead of the second message, a third message asking the occupant whether the activation may be executed is included. When the OTA master 10 has displayed the consent image on the display 50, the OTA master 10 determines the flow of the subsequent process according to whether the above-described consent condition is met. When the consent condition is met, the OTA master 10 moves the processing to step S26. On the other hand, when the consent condition is not met, the OTA master 10 temporarily ends displaying of the consent image and stands by until the system of the vehicle-to-be-updated 100A switches from on to off next time. When the system of the vehicle-to-be-updated 100A switches from on to off next time, the OTA master 10 displays the consent image on the display 50 again. When the consent condition is eventually met according to the occupant's operation, the OTA master 10 moves the processing to step S26.

In step S26, the OTA master 10 transmits second request information asking for permission for the activation to the management server 510. This second request information includes the vehicle identification value of the host vehicle, the software identification value of the specific software FAS, and information that inquires whether the activation of the specific software FAS may be executed. This second request information is status information showing that the update to the specific software FAS is at a stage before execution of the activation.

Upon receiving the second request information from the vehicle-to-be-updated 100A, the management server 510 performs the process of step S620. In step S620, the management server 510 determines whether it is necessary to cancel the update to the specific software FAS. When the management server 510 has not received the information on cancelation of application of the specific software FAS from when the process of step S618A has been ended until when the process of step S620 has been started, the management server 510 determines that it is not necessary to cancel the update. In this case, the management server 510 performs the process of step S622A. On the other hand, as shown in FIG. 4, when the management server 510 has received the information on cancelation of application of the updated software FA from when the process of step S618A has been ended until when the process of step S620 has been started (step S700), the management server 510 performs a process of a second cancelation pattern to be described later.

As shown in FIG. 2, when the management server 510 has moved the processing to step S622A, the management server 510 transmits second permission information to the vehicle-to-be-updated 100A. The second permission information includes the software identification value of the specific software FAS and a second permission signal indicating permission for execution of the activation.

Upon receiving the second permission information from the management server 510, the OTA master 10 of the vehicle-to-be-updated 100A performs the process of step S28A. In step S28A, the OTA master 10 performs the activation for the specific software FAS of which the installation has been performed in step S22A. Specifically, the OTA master 10 transmits an instruction signal for enabling the specific software FAS to the electronic control device 90 to be updated. In response to this instruction signal, the electronic control device 90 to be updated enables the specific software FAS. For example, the electronic control device 90 changes the setting about the above-described reading flag that specifies the storage area to which software is to be read. Upon completion of enabling of the specific software FAS, the electronic control device 90 to be updated transmits a second completion signal indicating to that effect to the OTA master 10. The activation is completed when the OTA master 10 receives this second completion signal. Upon receiving the second completion signal, the OTA master 10 ends the vehicle-side process after performing required various processes. One of the required various processes is updating the contents of the software list stored in the first memory 21. Another of the required various processes is deleting the result information that has been stored in the first memory 21 in step S12. Another of the required various processes is deleting the specific software FAS that has been stored in the first memory 21 in step S16. In this connection, the specific software FAS that the OTA master 10 has transmitted to the electronic control device 90 in step S22A is copy data of the specific software FAS stored in the first memory 21. In step S614, the management server 510 may transmit, to the vehicle-to-be-updated 100A, divided data or compressed data of the specific software FAS, or differential data between the specific software FAS and the software F stored in the second memory 92. In this case, in step S22A, the OTA master 10 may transmit the received divided data, compressed data, or differential data to the electronic control device 90. Alternatively, in step S22A, the OTA master 10 may generate specific software FAS from the received divided data, compressed data, or differential data and transmit the generated specific software FAS to the electronic control device 90.

### First Cancelation Pattern

The first cancelation pattern will be described. As shown in FIG. 3, from when the process of step S614 is ended until when the process of step S616 is started, the management server 510 sometimes receives the information on cancelation of application of the updated software FA in step S700. In this case, in the determination as to the necessity of cancelation in step S616, the management server 510 determines that it is necessary to cancel the update to the specific software FAS. In this case, the management server 510 performs the process of step S618B of FIG. 3 instead of the process of step S618A of FIG. 2. In step S618B, the management server 510 transmits first cancelation information to the vehicle-to-be-updated 100A. The first cancelation information includes the software identification value of the specific software FAS and a first cancelation signal ordering that execution of the installation be canceled. The first cancelation signal is a cancelation signal ordering that execution of the update to the updated software FA be canceled. The management server 510 transmits the cancelation signal to the OTA master 10 of the vehicle-to-be-updated 100A before execution of the installation. The first cancelation signal is specified beforehand as a signal different from the first permission signal.

Upon receiving the first cancelation information from the management server 510, the OTA master 10 of the vehicle-to-be-updated 100A performs the process of step S22B. In step S22B, the OTA master 10 deletes the specific software FAS that has been stored in the first memory 21 in step S16. Further, the OTA master 10 deletes also the result information that has been stored in the first memory 21 in step S12. Thereafter, the OTA master 10 ends the vehicle-side process. Parts of FIG. 3 where processes corresponding to those of FIG. 2 are performed are denoted by the same step numbers as in FIG. 2. In FIG. 3, depiction of the steps preceding step S614 and step S18 is omitted.

### Second Cancelation Pattern

The second cancelation pattern will be described. As shown in FIG. 4, from when the process of step S618A is ended until when the process of step S620 is started, the management server 510 sometimes receives the information on cancelation of application of the specific software FAS in step S700. In this case, in the determination as to the necessity of cancelation in step S620, the management server 510 determines that it is necessary to cancel the update to the specific software FAS. In this case, the management server 510 performs the process of step S622B of FIG. 4 instead of the process of step S622A of FIG. 2. In step S622B, the management server 510 transmits second cancelation information to the vehicle-to-be-updated 100A. The second cancelation information includes the software identification value of the specific software FAS and a second cancelation signal ordering that execution of the activation be canceled. The second cancelation signal is a cancelation signal ordering that execution of the update to the updated software FA be canceled. The management server 510 transmits the cancelation signal to the OTA master 10 of the vehicle-to-be-updated 100A before execution of the activation. The second cancelation signal is specified beforehand as a signal different from the second permission signal.

Upon receiving the second cancelation information from the management server 510, the OTA master 10 of the vehicle-to-be-updated 100A performs the process of step S28B. In step S28B, the OTA master 10 transmits an instruction signal for deleting the specific software FAS that has been stored in step S22A to the electronic control device 90 to be updated. In response to this instruction signal, the electronic control device 90 to be updated deletes the specific software FAS stored in the second memory 92. Upon completion of deletion of the specific software FAS, the electronic control device 90 to be updated transmits a third completion signal indicating to that effect to the OTA master 10. The deletion of the specific software FAS is completed when the OTA master 10 receives this third completion signal. Upon receiving the third completion signal, the OTA master 10 ends the vehicle-side process. As in the case of the first cancelation pattern, when ending the vehicle-side process, the OTA master 10 deletes the specific software FAS that has been stored in the first memory 21 in step S16 as well as the result information that has been stored in the first memory 21 in step S12. Parts of FIG. 4 where processes corresponding to those of FIG. 2 are performed are denoted by the same step numbers as in FIG. 2. In FIG. 4, depiction of the steps preceding step S618A and step S24 is omitted.

### Workings of Embodiment

Now, it is assumed as follows: In step S16 of FIG. 2, the OTA master 10 of the vehicle-to-be-updated 100A has downloaded the specific software FAS. Thereafter, in step S18, the OTA master 10 has displayed the consent image for the installation on the display 50. The period during which the occupant does not consent to execution of the installation in response to displaying of this consent image has continued for a long time. In such a case where execution of the installation is postponed, a defect is sometimes found in the specific software FAS within the period of postponement. It is assumed that, as shown in FIG. 3, before the management server 510 receives the first request information from the OTA master 10, the management server 510 has received the information on cancelation of application of the specific software FAS in step S700. In this case, upon receiving the first request information from the OTA master 10, the management server 510 performs the following: In step S618B, the management server 510 transmits the first cancelation information including an order that execution of the installation be canceled to the OTA master 10. In response, in step S22B, the OTA master 10 deletes the specific software FAS from the first memory 21.

A case different from the above-described one will be considered. Now, it is assumed as follows: In step S22A of FIG. 2, the OTA master 10 of the vehicle-to-be-updated 100A has completed the installation of the specific software FAS. Thereafter, in step S24, the OTA master 10 has displayed the consent image for the activation on the display 50. The period during which the occupant does not consent to execution of the activation in response to displaying of this consent image has continued for a long time. In such a case where execution of the activation is postponed, a defect is sometimes found in the specific software FAS within the period of postponement. It is assumed that, as shown in FIG. 4, before the management server 510 receives the second request information asking for permission for the activation from the OTA master 10, the management server 510 has received the information on cancelation of application of the specific software FAS in step S700. In this case, upon receiving the second request information from the OTA master 10, the management server 510 performs the following: In step S622B, the management server 510 transmits the second cancelation information including an order that execution of the activation be canceled to the OTA master 10. In response, in step S28B, the OTA master 10 deletes the specific software FAS from the electronic control device 90 to be updated.

### Advantages of Embodiment

(1) In the case where the management server 510 of this embodiment has received the information on cancelation of application of the updated software FA before the OTA master 10 of the vehicle-to-be-updated 100A executes the activation, the management server 510 performs the following: The management server 510 transmits the cancelation signal ordering that execution of the update to the updated software FA be canceled to the OTA master 10. In response to this cancelation signal, the OTA master 10 cancels the update to the updated software FA. Thus, in the configuration of this embodiment, if a defect in the updated software FA is found before the OTA master 10 executes the activation, execution of the update to the defective updated software FA can be canceled. Such a configuration of this embodiment reduces the likelihood that the update to the defective updated software FA is performed.

(2) It is possible that, after the OTA master 10 of the vehicle-to-be-updated 100A has completed the update to the updated software FA, the management server 510 may receive the information on cancelation of application of the updated software FA. It is hypothetically assumed that thereafter the management server 510 transmits the cancelation signal to the vehicle-to-be-updated 100A. In this case, since the update to the updated software FA has already been completed in the vehicle-to-be-updated 100A, the management server 510 unnecessarily transmits the cancelation signal.

In this respect, in performing the update to the updated software FA, the OTA master 10 of this embodiment transmits the status information showing that the installation or the activation is yet to be executed to the management server 510. The management server 510 transmits the cancelation signal to the OTA master 10 so as to respond to such status information. It can be said that the management server 510 transmits the cancelation signal to the OTA master 10 based on the stage of the update to the updated software FA that is grasped from the status information. In such a configuration of this embodiment, the management server 510 is unlikely to unnecessarily transmit the cancelation signal. As a result, the OTA master 10 is unlikely to unnecessarily receive the cancelation signal, either. To sum up, in the configuration of this embodiment, as unnecessary processing can be eliminated, the burden of processing on the management server 510 and the OTA master 10 can be relieved.

(3) In addition to (2), as the status information showing that the installation is yet to be executed is transmitted from the OTA master 10 to the management server 510, the following becomes possible in this embodiment: The management server 510 transmits the cancelation signal before the OTA master 10 executes the installation. In this case, the OTA master 10 deletes the updated software FA from the first memory 21 before executing the installation. In this case, storing the defective updated software FA in the electronic control device 90 to be updated can be avoided. Here, when the OTA master 10 performs the installation, the electronic control device 90 to be updated performs the following: The electronic control device 90 to be updated stores the updated software FA in the second memory 92 and transmits a signal to the effect that storing of the updated software FA has been completed to the OTA master 10, concurrently with main processing that is required in controlling the on-board device to be controlled as the target. When storing the defective updated software FA in the electronic control device 90 to be updated is avoided as in this embodiment, the following becomes possible: The electronic control device 90 to be updated can be prevented from bearing the burden of processing other than the main processing that the electronic control device 90 is originally supposed to perform.

### Modified Examples

The above-described embodiment can be modified as follows. The above-described embodiment and the following modified examples can be combined with one another within such a range that no technical inconsistency arises.

The contents of the vehicle-side process are not limited to the example of the above-described embodiment. At least, the vehicle-side process should be such that the update to the updated software FA can be completed through the three stages of processing of the downloading, the installation, and the activation. At least, the vehicle-side process should be such that the update to the updated software FA can be canceled when the cancelation signal is received from when the update to the updated software FA is started until when it is completed. The server-side process is not limited to the example of the above-described embodiment. At least, the server-side process should have such contents that the vehicle-side process can be appropriately responded to. At least, the server-side process should be such that, when cancelation of application of the updated software FA is received, the cancelation signal can be transmitted to the OTA master 10 of the vehicle-to-be-updated 100A to which the updated software FA has already been transmitted.

Regarding changing the contents of the vehicle-side process, for example, one or both of the downloading and the installation may be performed while the system of the vehicle-to-be-updated 100A is off. For example, in the case where the installation is performed while the system of the vehicle-to-be-updated 100A is off, the contents of the process of step S18 may be changed as follows: In step S18, the OTA master 10 stands by until the system of the vehicle-to-be-updated 100A switches from on to off. When the system of the vehicle-to-be-updated 100A switches from on to off, the OTA master 10 displays the consent image on the display 50. After obtaining consent from the occupant in response to the consent image, the OTA master 10 performs the processes of step S20 and the subsequent steps. In the case where this aspect is adopted, the contents of the process of step S24 may be changed, for example, as follows: After completion of the installation, the OTA master 10 stands by until the next vehicle trip ends. When the next vehicle trip ends and the system of the vehicle-to-be-updated 100A switches from on to off, the OTA master 10 displays the consent image on the display 50. Thereafter, the OTA master 10 performs the processes of step S26 and the subsequent steps.

Depending on the type of the updated software FA, some pieces of updated software FA can be activated while the system of the vehicle-to-be-updated 100A is on. If an update to such updated software FA is performed, the contents of the vehicle-side process may be changed so as to perform the activation while the system of the vehicle-to-be-updated 100A is on.

It is not essential to obtain consent of the occupant in advance in executing each of the downloading, the installation, and the activation. That is, one or more steps among step S12, step S18, and step S24 may be omitted. For example, step S18 and step S24 may be omitted. In this case, the following aspect may be adopted for the processes of step S20 and the subsequent steps: In step S20, the OTA master 10 stands by until the system of the vehicle-to-be-updated 100A switches from on to off. When the system of the vehicle-to-be-updated 100A switches from on to off, the first request information is transmitted. Thereafter, the processes of the subsequent steps are promptly performed. In the case where the processes of step S18 and step S24 are omitted, the following aspect may be adopted: In step S12, in addition to consent for the downloading being received, the occupant can set scheduled date and time for performing the installation and the activation. In step S20, the OTA master 10 stands by until the set scheduled date and time comes, and transmits the first request information when the scheduled date and time comes. Thereafter, the processes of the subsequent steps are promptly performed. In a case such as where, for example, the activation cannot be performed at the scheduled date and time in relation to the on or off status of the system of the vehicle-to-be-updated 100A, the occupant may be allowed to set new scheduled date and time at that point. Without being limited to these examples, in the case where prior consent is omitted, the process of each step should be performed at an appropriate timing such that the update to the updated software FA can be accomplished. In the case where the three of prior consent in step S12, step S18, and step S24 are all omitted, it is conceivable to allow the occupant to grasp the presence of an update by, for example, allowing the occupant to set the start date and time of the vehicle-side process itself. Here, when the prior consent is omitted, there are no longer processes that serve as triggers for the OTA master 10 to transmit the first request information and the second request information. Also in such a case, the management server 510 can grasp the stage of the update to the updated software FA if the OTA master 10 transmits these pieces of request information in advance when the stage of performing the installation or the activation is reached.

The timing for the management server 510 to transmit the cancelation signal is not limited to the example of the above-described embodiment. From the viewpoint of transmitting the cancelation signal before completion of the update to the updated software FA, the following aspect is also possible. As a premise, it is assumed that the OTA master 10 transmits the second request information to the management server 510 without fail at a stage before execution of the activation.

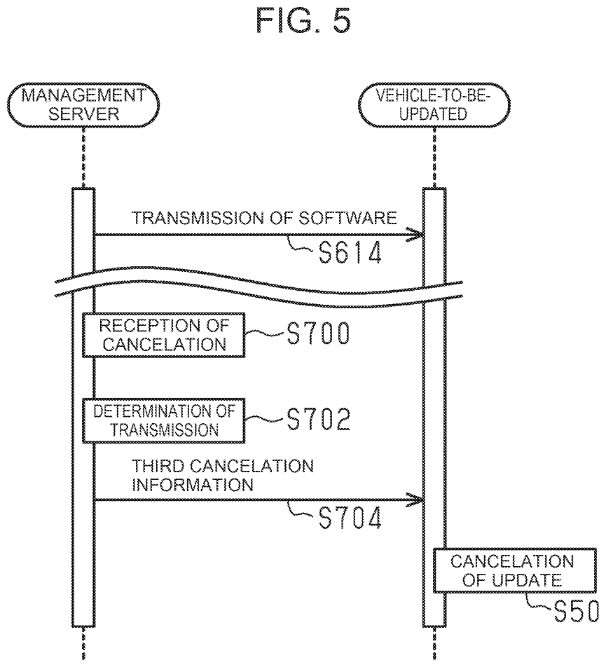

Now, it is assumed as follows: As shown in FIG. 5, in step S614, the management server 510 has transmitted the updated software FA to the vehicle-to-be-updated 100A. Thereafter, in step S700, the management server 510 has received the information on cancelation of application of the updated software FA. In this case, the management server 510 performs the process of step S702. That is, in step S702, the management server 510 performs determination as to the necessity of transmission. Specifically, the management server 510 determines whether the above-described second request information showing that the activation is yet to be executed has been received from the OTA master 10 of the vehicle-to-be-updated 100A. When the second request information has not yet been received, the management server 510 executes the process of step S704. In step S704, the management server 510 transmits third cancelation information to the vehicle-to-be-updated 100A. The third cancelation information includes the software identification value of the specific software FAS and a third cancelation signal ordering that execution of the update to the updated software FA be canceled. The third cancelation signal is a cancelation signal ordering that the update to the updated software FA be canceled regardless of the stage of the update such as the installation or the activation.

Upon receiving the third cancelation information, the OTA master 10 of the vehicle-to-be-updated 100A performs the process of step S50. In step S50, the OTA master 10 cancels the update to the specific software FAS. For example, when the timing of receiving the third cancelation information is before execution of the installation, the OTA master 10 deletes the specific software FAS stored in its first memory 21. For example, when the timing of receiving the third cancelation information is after execution of the installation and before execution of the activation, the OTA master 10 deletes the specific software FAS from the electronic control device 90 to be updated.

Regarding the process of step S702, when the second request information has already been received, the management server 510 directly ends the server-side process. In the case of the modified example of FIG. 5, the set of step S700, step S702, and step S704 constitutes one server-side process. In the case of the modified example of FIG. 5, the management server 510 starts this set of processes by being triggered by input of the information on cancelation of application through the input device 505.

Regarding the modified example of FIG. 5, the status information to which the management server 510 refers in performing the determination as to the necessity of transmission in step S702 is not limited to the second request information. Here, the status information to which the management server 510 refers in step S702 will be referred to as reference status information. For example, as the reference status information, installation completion information showing that the installation of the updated software FA has been completed may be adopted. In this case, the OTA master 10 should be configured to transmit the installation completion information to the management server 510 at the point when the installation has been completed. In step S702 of FIG. 5, the management server 510 should determine the necessity of step S704 according to whether the installation completion information has already been received. Or, as the reference status information, for example, activation completion information showing that the activation of the updated software FA has been completed may be adopted. In this case, the OTA master 10 should be configured to transmit the activation completion information to the management server 510 at the point when the activation has been completed. In the case where the activation completion information is adopted as the reference status information, the following can happen. Now, it is assumed as follows: The processing has moved to step S702. At that point, the management server 510 has not yet received the activation completion information. In this case, the management server 510 transmits the third cancelation information in step S704. In response to this third cancelation information, the OTA master 10 of the vehicle-to-be-updated 100A cancels the update to the updated software FA in step S50. It is possible that at that point the OTA master 10 is in the middle of executing the activation. Also in this case, if the activation has not been completed, the update can be stopped at that point as the OTA master 10 immediately halts the activation.

As described in the above-described modified example, the status information is not limited to the example of the above-described embodiment. The status information may be any information that shows at which stage the update to the updated software FA is in the sequence of processing from the start to completion of the update to the updated software FA.

It is not essential for the OTA master 10 to transmit the status information. For example, in the aspect shown in FIG. 2, the processes of step S20 and step S26 may be omitted. In association with this, the processes of responding performed by the management server 510, for example, step S616, step S618A, step S620, and step S622A may be omitted. On this basis, when the information on cancelation of application of the updated software FA is received, the management server 510 may perform the following: The management server 510 transmits the cancelation signal ordering that execution of the update to the updated software FA be canceled to the vehicle-to-be-updated 100A to which the updated software FA has already been transmitted. In this case, at the point when the cancelation signal is received, the OTA master 10 of the vehicle-to-be-updated 100A may be in a first status of having already completed the update or may be in a second status of having not yet completed the update. In the case of the first status, the OTA master 10 need not do anything upon receiving the cancelation signal. In the case of the second status, the OTA master 10 should cancel the update.

The aspect of receiving the information on cancelation of application of the updated software FA is not limited to the example of the above-described embodiment. For example, the operator may directly input the identification value of the updated software FA of which application is to be canceled. The management server 510 may receive that input information. Further, for example, the information on cancelation of application of the updated software FA may be received not through the input device 505 but by means of wireless communication. The form of receiving the information on cancelation of application of the updated software FA does not matter as long as it can be received.

In the above-described embodiment, the flow of performing the update to the updated software FA with one updated software FA as the target has been described. However, it is also possible that there is, at one time, a plurality of pieces of updated software FA applicable to one vehicle-to-be-updated 100A. In this case, the update to each piece of updated software FA may be performed or the update may be canceled by, for example, the following aspect. Here, description will be given based on the flow of the process of FIG. 2. In this description, description of contents overlapping with the above-described embodiment will be abbreviated or omitted as appropriate.

In the case where there is a plurality of pieces of updated software FA applicable to the vehicle-to-be-updated 100A, in step S610, the management server 510 specifies the plurality of pieces of updated software FA. In step S612, the management server 510 includes their individual software identification values in the result information. In this case, in step S14, the OTA master 10 of the vehicle-to-be-updated 100A includes, in the software request information, the software identification values included in the result information. In step S16, the OTA master 10 downloads all the plurality of pieces of updated software FA. Thereafter, in step S20, the OTA master 10 includes, in the first request information, the software identification values included in the result information as in step S14. In response, in step S616, the management server 510 performs the determination of cancelation. In this case, the management server 510 performs the determination of cancelation individually for each of the plurality of pieces of updated software FA being the targets. Then, the management server 510 transmits the first permission information or the first cancelation information individually to each of the pieces of updated software FA being the targets. Thereafter, the OTA master 10 executes the installation or cancels execution of the installation individually for each of the pieces of updated software FA being the targets. Thus, the processes of step S616 and the subsequent steps are performed individually for each of the pieces of updated software FA being the targets. If the information on the software identification values is available, the management server 510 as well as the OTA master 10 can accomplish each process while appropriately distinguishing the pieces of updated software FA being the targets. In this way, the vehicle-side process and the server-side process can also be applied to an update to a plurality of pieces of updated software FA.

In the above-described embodiment, the flow of performing the update to the updated software FA with one vehicle-to-be-updated 100A as the target has been described. However, it is of course also possible that the update to the updated software FA is concurrently performed in a plurality of vehicles-to-be-updated 100A.

As the non-volatile memories included in the electronic control device 90, memories with a single-bank structure may be adopted. Unlike the double-bank structure, there is only one storage area in a memory with the single-bank structure. This memory cannot be written into while data is being read from it. With this taken into account, in the case where a non-volatile memory with the single-bank structure is adopted, it is conceivable to perform the installation in addition to the activation while the system of the vehicle-to-be-updated 100A is off.

For one vehicle 100, memories with the double-bank structure may be adopted as the non-volatile memories in some of the plurality of electronic control devices 90, and memories with the single-bank structure may be adopted as the non-volatile memories in the other electronic control devices 90. In this case, the vehicle-side process should be adjusted such that the installation and the activation can be performed at appropriate timings for each electronic control device 90.

Non-volatile memories with different structures may be adopted for the first memory and the second memory 92 in the same electronic control device 90.

One non-volatile memory may serve as both the first memory and the second memory 92 in the same electronic control device 90.

The above-described modified examples relating to the non-volatile memories are also applicable to the OTA master 10. That is, memories with the single-bank structure may be adopted as the non-volatile memories of the OTA master 10. Non-volatile memories with different structures may be adopted for the first memory 21 and the second memory 22. One non-volatile memory may serve as both the first memory 21 and the second memory 22.

The OTA master 10 may update its software using the same technique as that of the above-described embodiment. In this case, the OTA master 10 itself constitutes the electronic control device of which the software is to be updated.

The overall configuration of the vehicle 100 is not limited to the example of the above-described embodiment. For example, it is also possible that the drive source of the vehicle 100 is a motor-generator instead of or in addition to the engine.

The configuration of the server unit 500 is not limited to the example of the above-described embodiment. For example, the display 503 may be of touch-screen type. The display 503 may function as an input device. At least, the server unit 500 should be configured to be able to fulfill the function of the server-side process.

The processing circuit 11 of the OTA master 10 may have any of the following configurations (a) to (c). The same applies to the processing circuit of the electronic control device 90 and the processing circuit 511 of the management server 510.

(a) The processing circuit 11 includes one or more processors that execute various processes in accordance with computer programs. Each processor includes a CPU and one or more memories such as a RAM and a ROM. Each memory stores program codes or commands configured to make the CPU execute processes. The term “memory,” i.e., computer-readable medium covers all available media that can be accessed by a general-purpose or special-purpose computer.

(b) The processing circuit 11 includes one or more dedicated hardware circuits that execute various processes. Examples of dedicated hardware circuits include an integrated circuit for specific applications, or ASIC, and an FPGA. ASIC is short for “application-specific integrated circuit.” and FPGA is short for “field-programmable gate array.”

(c) The processing circuit 11 includes a processor that executes some of various processes in accordance with computer programs, and a dedicated hardware circuit that executes the other processes of the various processes.

What is claimed is:

1. A server comprising one or more processors configured to:
transmit updated software to vehicle that is registered;
receive information on cancelation of application of the updated software; and
in response to receiving the information on cancelation of application of the updated software, transmit, to the vehicle to which the updated software has already been transmitted, a cancelation signal ordering cancelation of an update to the updated software.

2. The server according to claim 1, wherein the one or more processors are configured to:
receive, from the vehicle, status information showing at which stage from start to completion the update to the updated software is; and
transmit the cancelation signal to the vehicle in which the update to the updated software has not been completed.

3. A method of updating software by a computer, the method comprising the computer executing:
transmitting updated software to vehicle that is registered;
receiving information on cancelation of application of the updated software; and
in response to receiving the information on cancelation of application of the updated software, transmitting, to the vehicle to which the updated software has already been transmitted, a cancelation signal ordering cancelation of an update to the updated software.

4. A non-transitory storage medium storing a command that is executable by the computer and that makes the computer executes the method according to claim 3.

5. A software update system comprising:
a server; and
an information processing device that is installed in vehicle and configured to communicate with the server, wherein:
the server is configured to
transmit updated software to the information processing device, and
receive information on cancelation of application of the updated software;
the information processing device is configured to
receive the updated software from the server, and
perform an update to the updated software for an electronic control device installed in the vehicle;
the server is configured to, in response to receiving the information on cancelation of application of the updated software, transmit, to the information processing device to which the updated software has already been transmitted, a cancelation signal ordering cancelation of the update to the updated software; and
the information processing device is configured to, in response to receiving the cancelation signal from the server before completion of the update to the updated software, cancel the update to the updated software.

6. The software update system according to claim 5, wherein:
in performing the update to the updated software, the information processing device is configured to
perform downloading to receive the updated software from the server,
perform installation to store the updated software obtained by the downloading in the electronic control device,
perform activation to enable the updated software of which the installation has been performed, and
transmit, to the server, status information showing at which stage among the downloading, the installation, and the activation the update to the updated software is; and
the server is configured to transmit the cancelation signal to the information processing device in which the activation has not been completed.

7. The software update system according to claim 6, wherein:
the server is configured to transmit the cancelation signal to the information processing device in which the installation is yet to be executed; and
the information processing device is configured to, in response to receiving the cancelation signal, delete the updated software before storing the updated software in the electronic control device.
